(19) United States
(12) Patent Application Publication
(10) Pub. No.: US 2009/0127204 A1
(43) Pub. Date: May 21, 2009

(54) DEVICE AND METHOD FOR THE TREATMENT OF BIOMASSES WITH PERMANENT MAGNETS

(76) Inventor: Tonio Meier, Gessertshausen (DE)

Correspondence Address: GREER, BURNS & CRAIN, 300 S WACKER DR, 25TH FLOOR, CHICAGO, IL, 60606, US

(21) Appl. No.: 11/994,815

(22) PCT Filed: Jul. 5, 2006
(86) PCT No.: PCT/DE2006/001160

§ 371 Date: Aug. 1, 2008

(30) Foreign Application Priority Data
Jul. 7, 2005 (DE) 10 2005 031 873.8

(51) Int. Cl. C02F 1/48; H01F 7/02; C02F 103/00; C02F 11/00

(52) U.S. Cl. 210/695; 335/306; 210/222

(57) ABSTRACT

A device for the treatment of biomass, including: a biomass cavity; a first magnet arrangement having at least one first permanent magnet; and a second magnet arrangement having at least one second permanent magnet; all first permanent magnets of the first magnet arrangement being situated on the outer periphery of the cavity, with their north poles oriented toward the cavity and their south poles oriented away from the cavity; and all second permanent magnets of the second magnet arrangement being situated on the outer periphery of the cavity with their south poles oriented toward the cavity and their north poles oriented away from the cavity; so that the flux lines from a north pole of a first permanent magnet to a south pole of at least one second permanent magnet run in the cavity, the first and second magnet arrangement each comprise a plurality of first or, second permanent magnets.

The present invention relates to a device for treatment of biomass, in particular sewage sludge, according to the preamble of Claim 1, as well as a method for the treatment of biomass, in particular sewage sludge, according to the preamble of Claim 11.

### BACKGROUND OF THE INVENTION

In the following, the present invention is explained in more detail in relation to the example of the treatment of sewage sludge. However, the present invention also relates generally to the treatment of arbitrary other biomasses.

Currently, waste water is usually treated by being first coarsely mechanically pre-cleaned using a screen or sieve device. The resulting screened material can be digested and composted.

The waste water than passes into a sedimentation tank in which solid particles sink to the floor, where they are collected as a suspension or sludge, are cleaned out, and are supplied to a sludge digesting facility in which anaerobic bacterial decomposition takes place under airtight conditions. The digestible fresh sludge is decomposed, which gives rise to a gas that can be introduced for example into a city gas supply network. The remaining digested sludge can be used as fertilizer.

The contaminants and foreign materials still present in the waste water after this mechanical cleaning are removed and processed in a subsequent biological waste water cleaning process. This takes place aerobically with a sufficient supply of air; in one or more activated sludge tanks, bacteria float in the waste water and decompose organic contaminants. The resulting activated sludge can be collected according to its specific weight at the surface of the water or at the bottom of the activated sludge tank or post-existing installations is expensive, and also requires constant regulation of the produced field strengths and monitoring of the functionality. This monitoring, regulation, and energy supply is expensive, difficult, and liable to failure, as well as being retrofittable only with difficulty, due to the long uninterrupted operating times of treatment plants and the harsh, in particular corrosive, environmental conditions present there. The same holds analogously for the use of ultrasound. In addition, both methods have undesirable side effects. For example, extended use of ultrasound results in fatigue to the water pipes of the treatment plants, and electromagnetic alternating fields can, as electrosmog, have a harmful effect on operating personnel.

The permanent magnetic field in DE 101 18 839 A1 avoids these disadvantages. However, this is a homogenous magnetic field whose flux lines are oriented essentially parallel to the direction of flow of the sewage sludge.

WO 95/15922 relates to the treatment of water using a static magnetic field of at least 6000 gauss, produced by permanent magnets. Here, the water flows through an annular gap between a positive and a negative magnetic pole, so that a homogenous radial magnetic field charges the water flowing through.

JP 60-082190 A relates to the treatment of activated sludge using permanent magnets that are situated on the periphery of a treatment tank in order to produce oxygen in the sludge. The orientation of the flux lines is not indicated.

DE 23 61 056 A1 relates to a method for increasing the growth rate of microorganisms in biological waste water installations. For this purpose, this publication proposes the use of electromagnets or permanent magnets. In an embodiment described in more detail, the flux lines of an electromagnet, in the form of a coil wound around a pipe, penetrate the waste water flowing through the pipe homogenously, in the direction perpendicular to the direction of flow.

existing installations is expensive, and also requires constant regulation of the produced field strengths and monitoring of the functionality. This monitoring, regulation, and energy supply is expensive, difficult, and liable to failure, as well as being retrofittable only with difficulty, due to the long uninterrupted operating times of treatment plants and the harsh, in particular corrosive, environmental conditions present there. The same holds analogously for the use of ultrasound. In addition, both methods have undesirable side effects. For example, extended use of ultrasound results in fatigue to the water pipes of the treatment plants, and electromagnetic alternating fields can, as electrosmog, have a harmful effect on operating personnel.

The permanent magnetic field in DE 101 18 839 A1 avoids these disadvantages. However, this is a homogenous magnetic field whose flux lines are oriented essentially parallel to the direction of flow of the sewage sludge.

WO 95/15922 relates to the treatment of water using a static magnetic field of at least 6000 gauss, produced by permanent magnets. Here, the water flows through an annular gap between a positive and a negative magnetic pole, so that a homogenous radial magnetic field charges the water flowing through.

JP 60-082190 A relates to the treatment of activated sludge using permanent magnets that are situated on the periphery of a treatment tank in order to produce oxygen in the sludge. The orientation of the flux lines is not indicated.

DE 23 61 056 A1 relates to a method for increasing the growth rate of microorganisms in biological waste water installations. For this purpose, this publication proposes the use of electromagnets or permanent magnets. In an embodiment described in more detail, the flux lines of an electromagnet, in the form of a coil wound around a pipe, penetrate the waste water flowing through the pipe homogenously, in the direction perpendicular to the direction of flow.

Surprisingly, tests have shown that the charging of biomass, in particular sewage sludge, with a permanent magnetic field differing from the radial or homogenous fields known from the prior art for the treatment of sludge and waste water results in a significant increase in the heating gas produced from the biomass, in particular from the sewage sludge, and simultaneously results in a significant reduction of the remaining residual biomass or residual sewage sludge.

It is assumed that the magnetic field according to the present invention enables a significant increase in the performance, and thus the economic viability, of the biogas plant, due to the significantly improved cell breakdown of the charged biomasses that it brings about. In contrast to this, the above-cited JP 60-082190 A and DE 23 61 056 A1 seek precisely to bring about an increased growth rate of the microorganisms. The magnetic field used in a device or method according to the present invention results, in contrast to this, to a destruction of the cells present in the biomass, in particular in the sewage sludge, and thus to the desired improved cell breakdown.

### OBJECT OF THE INVENTION

On the basis of the cited prior art, the object of the present invention is to reduce the residual biomass or residual sludge that occurs during the digestion of biomass, in particular sewage sludge.

### SUMMARY OF THE INVENTION

For this purpose, a device according to the preamble of Claim 1 and a method according to the preamble of Claim 11 are described in more detail through their characterizing features.

According to the present invention, a device for treating biomass, in particular sewage sludge, has a cavity for accommodating the biomass or the sewage sludge, a first magnet arrangement having at least one first permanent magnet and a second magnet arrangement having at least one second permanent magnet, such that all first permanent magnets of the first magnet arrangement are situated on the outer periphery of the cavity with their north poles oriented toward the cavity and their south poles oriented away from the cavity, and all second permanent magnets of the second magnet arrangement are situated on the outer periphery of the cavity with their south poles oriented toward the cavity and their north poles oriented away from the cavity.

Thus, the flux lines from a north pole of a first permanent magnet to a south pole of at least one second permanent magnet run in the cavity. This magnetic field not only breaks down the cells in the biomasses, but also accelerates and intensifies the cellular digesting process. This advantageously increases the quantity of usable biogas, which can be utilized in particular as heating gas, by 20 to 50% in trials. At the same time, the residual biomass that occurs and that is to be removed is reduced by 20 to 30% in trials. In particular, there is a significant reduction in undesirable bulking sludge. In addition, there is an advantageous shortening of digesting times, up to 50% in trials.

In contrast to the treatments described above using ultrasound or electromagnetic alternating fields, a device according to the present invention does not require any external energy. In contrast to DE 101 18 839 A1, it can also be retrofitted very easily to existing waste water treatment plants or other biogas facilities without interruption of operation; the permanent magnets can be attached detachably or fixedly to a flow line to the digesting chamber or to the digesting chamber itself without constructive modification of the existing plant.

The first and second magnet arrangements each have a plurality of first or, respectively, second permanent magnets, so that the field according to the present invention results inside the cavity, said field differing from the magnetic fields known from the prior art in that the field lines do not completely penetrate the cavity, but rather run from a north pole of a first permanent magnet to the south pole of a second permanent magnet. In this case, the first and second permanent magnets are preferably situated in a first direction perpendicular to their magnetic axis in alternating fashion, i.e. a first permanent magnet is followed by a second permanent magnet and vice versa. The first direction can be for example the axial direction, but can also be the peripheral direction of a pipe that forms the cavity. In a particularly preferred embodiment, three permanent magnets of the first or second magnet arrangement and two permanent magnets of the respective other magnet arrangement are situated in alternating fashion, so that a total of five rows of permanent magnets are present in the first direction.

In a second direction, perpendicular to their magnetic axis and to the first direction, first and second permanent magnets can also be situated in alternating fashion, so that overall on the outside of the cavity a checkerboard-type pattern of first and second permanent magnets results.

Alternatively, only first or second permanent magnets can be situated in this second direction, so that in the second direction a complete ring of first or, respectively, second permanent magnets extends around the cavity.

In trials, it has turned out to be advantageous to dimension and situate the permanent magnets in such a way that the magnetic flux inside the cavity is at most 1800 gauss, in particular at most 1500 gauss, and preferably less than 800 gauss. These lower field strengths prevent damage to the installation, in particular material fatigue as is known in devices according to the prior art, and also prevent harmful effects to the operating personnel resulting from strong electromagnetic radiation, while simultaneously achieving the improvements described above.

The permanent magnets are preferably strontium-ceramic magnets. These magnets enable extremely long life spans without significant decrease in the magnetic effect; over 90 years the field strength decreases only by approximately 1%.

The device according to the present invention can equally well be situated on a supply pipe for supplying biomass, in particular sewage sludge, to a digesting chamber, or on the digesting chamber itself.

If the biogas is also charged with the magnetic field using a device according to the present invention, the caloric value of the gas can be increased significantly (up to 20% in trials).

As biomass, in particular sewage sludge is possible, such as the fresh sludge, activated sludge, scum, and/or excess sludge that arises during one or more cleaning stages. The biomass used can also be processed in a plurality of operating steps. Here, according to the present invention the total sewage sludge or total biomass from each of the steps, or only a partial quantity thereof, can be charged with a magnetic field. The resulting residual sludge or residual biomass can be revitalized by a process according to the present invention and can be partially or wholly fed back into the waste water or sewage sludge that is to be treated.

### EXEMPLARY EMBODIMENT

Further objects, advantages, and features of the present invention result from the subclaims and from the exemplary embodiments. In these, the present invention is explained in more detail on the basis of the treatment of sewage sludge. However, as mentioned above, the present invention relates equally to the treatment of other biomasses, such as biomass produced in agriculture from waste plant material and/or animal excrement.

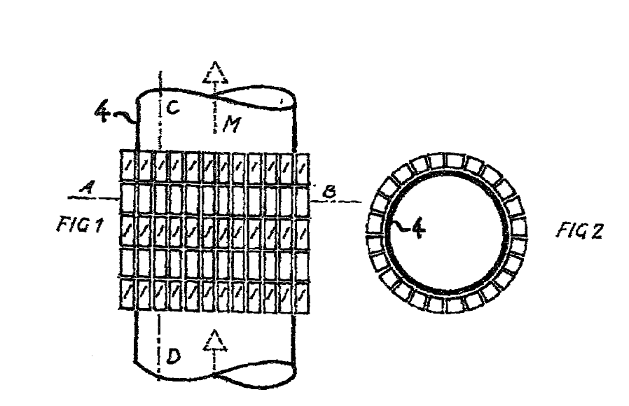

FIG. 1 shows a device for treating sewage sludge according to an embodiment of the present invention, in longitudinal section;

FIG. 2 shows a cross-section of FIG. 1 along the line A-B;

FIG. 3 shows a longitudinal section of FIG. 1 along the line C-D, with flux lines, and

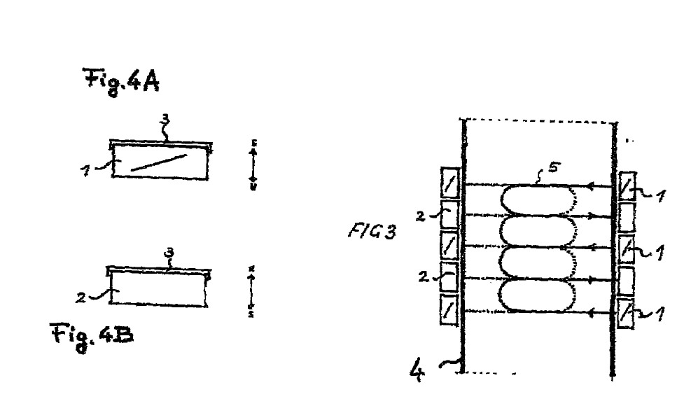

FIGS. 4A, 4B show a first or second permanent magnet.

In FIG. 1, sewage sludge M flows through a cavity 4, formed by a pipe, in the direction indicated by the dotted arrow. Sewage sludge M can for example be, inter alia, fresh sludge, activated sludge, excess sludge, or scum that occurs in a waste water treatment plant during chemical or biological waste water treatment at the screen, in the pre-treatment tank, in an activation tank, or in a post-treatment tank, and that is supplied to a digesting chamber. In each case, all the sewage sludge occurring in a stage may be supplied to the device according to the present invention, but it is equally possible for only a part of this sewage sludge to be so supplied.

It is not necessary that the sewage sludge flow; rather, it can also be at a standstill, e.g. in the digesting chamber itself. A corresponding embodiment of the present invention is not shown separately; rather, in this case reference character 4 in FIG. 1-FIG. 3 designates the digesting chamber itself.

Along the periphery of cavity 4, permanent magnets 1, 2 are situated with alternating polarity in such a way that first permanent magnets 1 are situated with their north poles oriented toward the sewage sludge and their south poles oriented away from the sewage sludge, while second permanent magnets 2, alternating with permanent magnets 1, are situated with their south poles oriented towards the sewage sludge and their north poles oriented away from the sewage sludge.

As is shown in FIG. 1 and FIG. 3, the alternating arrangement can take place in the axial direction of cavity 4 and/or (not shown) can equally well take place in the peripheral direction, so that in the axial and/or peripheral direction a first permanent magnet alternates with a second permanent magnet.

The alternating arrangement of alternately polarized permanent magnets 1, 2 results in the flux lines 5 shown schematically in FIG. 3, which run inside cavity 4 from the north pole, oriented toward the sewage sludge, of a first permanent magnet 1 to the south pole, oriented toward the sewage sludge, of the adjacent second permanent magnet 2, or to the south poles, oriented toward the sewage sludge, of the adjacent second permanent magnets 2. If, as shown in FIG. 2, the first and second magnets are distributed along the overall periphery of cavity 4, the resulting magnetic field penetrates the sewage sludge uniformly and in a particularly advantageous manner.

Preferably, the first and second permanent magnets are dimensioned and situated such that there results a magnetic flux of approximately 1500 gauss (0.15 T), particularly preferably a magnetic flux of approximately 1800 gauss (0.18 T). Each permanent magnet can be provided at its outer end facing away from the sewage sludge with a covering 3 made of sheet metal, plastic, or the like, in order to protect it from the harsh environmental conditions present in treatment plants. If these coverings are magnetizable or magnetic, they advantageously reinforce the magnetic flux shown in FIG. 3.

First and second permanent magnets 1, 2 can be connected fixedly or detachably to cavity 4, e.g. by gluing, screwing, press-fitting using tension belts, or the like. Preferably, the poles oriented toward the sewage sludge have a shape that corresponds to the outer wall of cavity 4. The magnets can also be cast, individually or in groups, in plastic or the like (not shown).

If, as shown in FIG. 1, the sewage sludge is exposed to a magnetic field produced by the arrangement according to the present invention of the permanent magnets before being introduced into the digesting chamber, or in the digesting chamber itself, this advantageously results, even at the preferred low field strengths, to destruction of the cell walls of the microorganisms and an accelerated cellular decomposition process. This significantly increases the biological activity—in trials, a device according to the embodiment depicted here of the present invention resulted in a reduction in the residual sludge of 20-30%. The quantity of heating gas produced from the sewage sludge was increased by 20-50%. Finally, the digesting time of the sewage sludge in the digesting chamber was reduced by up to 50%.

The biogas produced from the sewage sludge can also advantageously be exposed to a magnetic field in a similar manner. The arrangement corresponds to that shown in FIGS. 1-3; with the difference that here it is no longer sewage sludge, but rather heating gas M, that flows through cavity 4. The above-described arrangement of first and second permanent magnets 1, 2 produces a uniform magnetic field whose action significantly increases the caloric value of heating gas M (by up to 20% in trials).

As is known in treatment plants, the residual sludge can also be reintroduced to the process, wholly or in part. The charging with a magnetic field using the device according to the present invention revitalizes this residual sludge, so that the efficiency of the treatment plant is improved. In an embodiment of the present invention not shown separately, during the feedback of residual sludge to the treatment plant residual sludge M flows through a device according to the present invention as described in connection with FIGS. 1-3, thus revitalizing said sludge.

1. A device for the treatment of biomass, in particular sewage sludge, comprising:
a cavity for accommodating the biomass;
a first magnet arrangement having at least one first permanent magnet; and
a second magnet arrangement having at least one second permanent magnet;
all first permanent magnets of the first magnet arrangement being situated on the outer periphery of the cavity, with their north poles oriented toward the cavity and their south poles oriented away from the cavity; and
all second permanent magnets of the second magnet arrangement being situated on the outer periphery of the cavity with their south poles oriented toward the cavity and their north poles oriented away from the cavity;
so that the flux lines from a north pole of a first permanent magnet to a south pole of at least one second permanent magnet run in the cavity,
wherein said first and second magnet arrangement each comprise a plurality of first or, respectively, second permanent magnets.

2. The device as recited in claim 1, wherein said first and second permanent magnets are situated in alternating fashion in a first direction perpendicular to their magnetic axis.

3. The device as recited in claim 2, wherein in the first direction three permanent magnets of the first or second magnet arrangement and two permanent magnets of the respective other magnet arrangement are situated in alternating fashion.

4. The device as recited in claim 2, wherein said first and second permanent magnets are situated in alternating fashion in a second direction perpendicular to their magnetic axis and to the first direction.

5. The device as recited in claim 2, wherein in a second direction, perpendicular to the magnetic axis of the permanent magnets and to the first direction, only first or second permanent magnets respectively are arranged one after the other.

6. The device as recited in claim 1, wherein said magnetic flux inside the cavity is at most 1800 gauss, in particular at most 1500 gauss, preferably less than 800 gauss.

7. The device as recited in claim 1, wherein said first and/or second permanent magnets are strontium-ceramic magnets.

8. The device as recited in claim 1, wherein said cavity is a supply pipe for supplying biomass to a digesting chamber.

9. The device as recited in claim 1, wherein said cavity is a digesting chamber.

10. A method for treating biomass, in particular sewage sludge, comprising:
feeding of biomass into a digesting chamber;
digesting of the biomass in the digesting chamber;
drainage of the resulting residual biomass and of the resulting biogas;
during the feeding into the digesting chamber, and/or in the digesting chamber, the biomass is charged with a magnetic field using a device according to one of the preceding claims.

11. The method as recited in claim 10, wherein said biogas is also charged with a magnetic field using a device corresponding to a device for the treatment of biomass, in particular sewage sludge, the device comprising:
a cavity for accommodating the biomass;
a first magnet arrangement having at least one first permanent magnet; and
a second magnet arrangement having at least one second permanent magnet;
all first permanent magnets of the first magnet arrangement being situated on the outer periphery of the cavity, with their north poles oriented toward the cavity and their south poles oriented away from the cavity; and
all second permanent magnets of the second magnet arrangement being situated on the outer periphery of the cavity with their south poles oriented toward the cavity and their north poles oriented away from the cavity;
so that the flux lines from a north pole of a first permanent magnet to a south pole of at least one second permanent magnet run in the cavity,
wherein said first and second magnet arrangement each comprise a plurality of first or, respectively, second permanent magnets, the biogas being held in the cavity instead of the biomass.

12. The method as recited in claim 10, wherein as biomass sewage sludge is supplied wholly or in part, in particular the fresh sludge, activated sludge, scum, and/or excess sludge that arises in one or more cleaning stages, and/or the screened material that arises during pre-cleaning, and/or the residual sludge that arises during digesting.
